(19) United States
(12) Patent Application Publication
(10) Pub. No.: US 2008/0211154 A1
(43) Pub. Date: Sep. 4, 2008

(54) Apparatus Including Spring and Method For Tensioning the Same

(75) Inventor: Robert Firth, York (GB)

Correspondence Address: MCKEE, VOORHEES & SEASE, P.L.C., 801 GRAND AVENUE, SUITE 3200, DES MOINES, IA, 50309-2721, US

(73) Assignee: GMCA PTY, LTD., MELBOURNE (AU)

(21) Appl. No.: 11/997,939

(22) PCT Filed: Aug. 7, 2006
(86) PCT No.: PCT/GB2006/002945

§ 371 Date: Mar. 12, 2008

(30) Foreign Application Priority Data
Aug. 5, 2005 (GB) 0516121.1

(51) Int. Cl. F16F 1/06; B21D 39/00

(52) U.S. Cl. 267/155; 29/452

(57) ABSTRACT

The invention to which this application relates is to a mechanism for the tensioning of a spring, typically a coil spring (1) of the torsion type, said spring (1) having first (20) and second (22) arms which depend outwardly from either end of the coil and the spring (1) is provided to create a biasing force. The apparatus is typically a power tool and the invention provides an effective means of tension the spring (1) at the time of assembly of the tool by using components fitted as part of the tool.

The invention to which this application relates is to apparatus including, and a method for tensioning a spring, typically a coil spring of the torsion type. The invention is particularly suited to the tensioning of the spring at the time of assembly of the apparatus. The spring typically has first and second arms which depend outwardly from either end of the coil.

In accordance with the invention the spring is provided as part of the apparatus and is required to be tensioned in order to bias part of the apparatus to a required position. In one embodiment the apparatus is a power tool and the biasing force of the spring causes the power tool to be moved to a default storage position when not in use.

In order to place the torsion spring under a force so that the same acts as a biasing means on a component connected thereto, it is necessary to move the arms of the spring against the force of the coil and then retain the arms in that position with respect to the two components which are to be under the influence of the spring.

In many instances this can be difficult to achieve due to the need to fit together the two components to be acted upon by the torsion spring at the same time as maintaining the spring under tension.

This problem is found to be of particular relevance with regard to power tool components which are held under the influence of the torsion spring and, yet further, with particular regard to the provision of a power tool in the form of a saw which includes a cutting head which is pivotally movable between raised and lowered positions with respect to a guide arm, and/or slides and a base, such as a mitre saw, chop saw or grinding tool. In this type of tool the cutting head is provided with a rotatable blade and typically has a guard for the blade which can be moved between a safety position in which the blade is enclosed with the cutting head in the raised position, and an in use position in which the guard is moved and the blade exposed to allow the blade to be used to perform a cutting action. The torsion spring is provided to bias the cutting head to the raised position and/or possibly influence the movement of the guard.

The aim of the present invention is to provide a means of fitting together the components which are to be influenced by the torsion spring and to do so in a manner which aids the ease of manufacture and assembly of the components while ensuring that the spring is suitably tensioned.

In a first aspect of the invention there is provided apparatus including a torsion spring which acts to provide a biasing force, said apparatus including a pivotal connection between first and second components, provided under the influence of the spring so as to allow at least one of the components to be biased to a position with respect to the other of the components about said pivot axis, said spring including a coil and first and second arms depending from the coil, said apparatus having location means for at least a first arm of the torsion spring, and wherein a portion of the apparatus is rotated about the pivot axis to move one of the arms with respect to the other of the arms to tension the spring at which stage the said arms are retained in position.

In one embodiment, the location means for the first arm is a slot into which said arm is fitted, said slot typically located with regard to the component of the apparatus such that the second arm is, at the same time, then positioned for engagement with the component of the apparatus which is to be pivotally moved to tension the coil.

Typically, the spring coil is positioned over a spigot, said spigot coaxial with the pivot axis and said spigot serving to centre the spring.

In one embodiment, the spigot and location means for the first arm are located on the same component which is a fixed component, such as the base of a power tool. In one embodiment, the location means includes a slot through which the arm passes onto an opposing side of the component from the spigot, and continued movement of the spring then places both arms in position for subsequent use.

In one embodiment, once the arms are in the required position, a further component of the apparatus is attached for rotation about the pivotal axis, said component locating on at least one of the arms such that subsequent rotation of that component causes movement of the arm with which the same is engaged, but not the other arm so as to tension the spring.

Typically, once the further rotation of the spring has achieved the required position to tension the spring, the components and the spring are then locked in position such that the said components can then be rotated under the influence of the tension spring.

In one embodiment the apparatus is a power tool and the cutting head of the power tool is rotatably movable about the pivot axis between raised and lowered positions and is connected thereto, with the spring acting to return the cutting head and/or a portion mounted on the cutting head to a default position. In one embodiment the component which is used to rotate and tension the spring is an anchor piece for a guard mechanism which causes the guard for the saw blade on the cutting head to move between open and closed positions following movement of the cutting head.

In one embodiment, the tension spring is provided as part of a power tool in the form of a mitre saw, chop saw or compound saw wherein the tension spring acts to return the cutting head, which includes a cutting blade therewith, and/or a portion thereof back to a default position from a cutting position.

In a further aspect of the invention there is provided a method for tensioning a torsion spring provided as part of a power tool having a cutting head pivotally movable about a pivot axis between raised and lowered positions with respect to a fixed component on which the cutting head is mounted, said method comprising the steps of providing the torsion spring with first and second arms at opposing ends of the spring coil, placing the spring coil over a spigot mounted at the pivot axis, locating a first arm of the torsion spring with location means on a fixed component, and the second arm with location means on a second component and wherein the second component is rotated about the pivot axis to provide relative movement of the first and second arms and tension the torsion spring and locking means are then fitted to retain the torsion spring in the tensioned position.

In one embodiment the said further component is an anchor part for a guard movement mechanism for a guard mounted on the cutting head to allow the enclosure of the saw blade.

Specific embodiments of the invention are now described with reference to the accompanying drawings, wherein:—

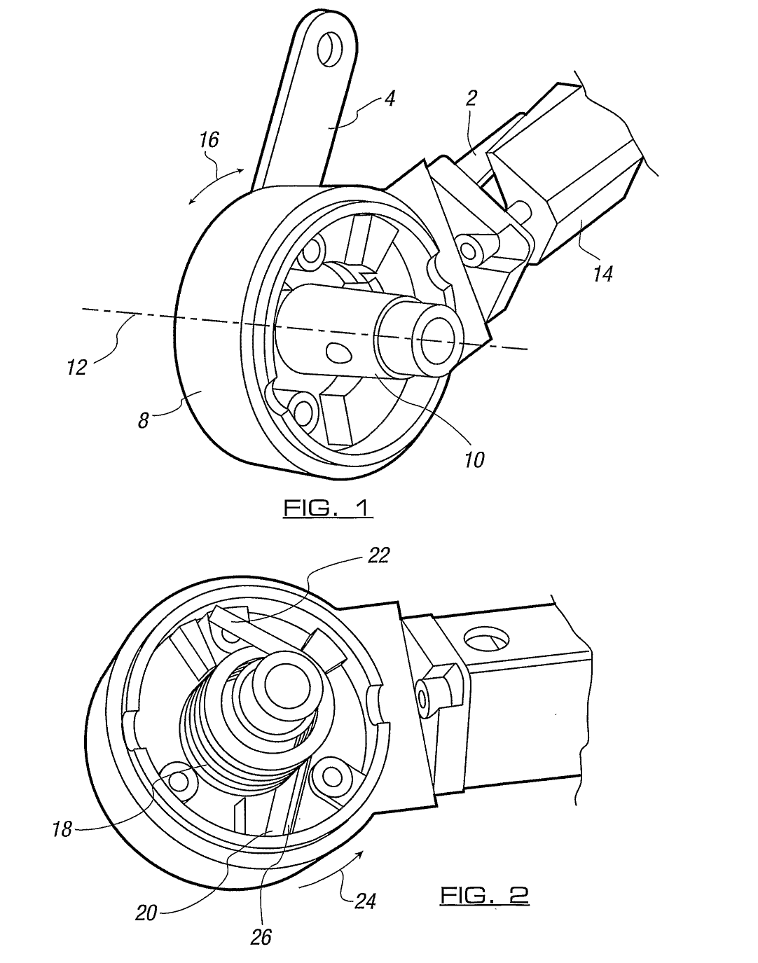

FIG. 1 illustrates the apparatus in accordance with one embodiment of the invention;

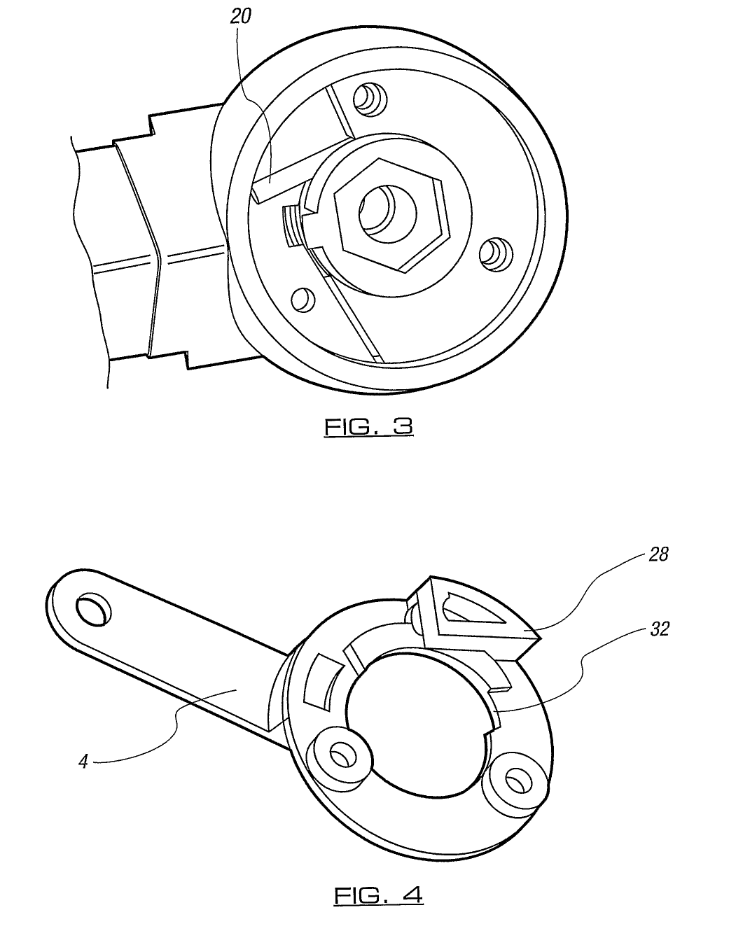

FIG. 2 represents part of the apparatus of FIG. 1 in a first stage;

FIG. 3 illustrates the apparatus of FIGS. 1 and 2 in a second stage;

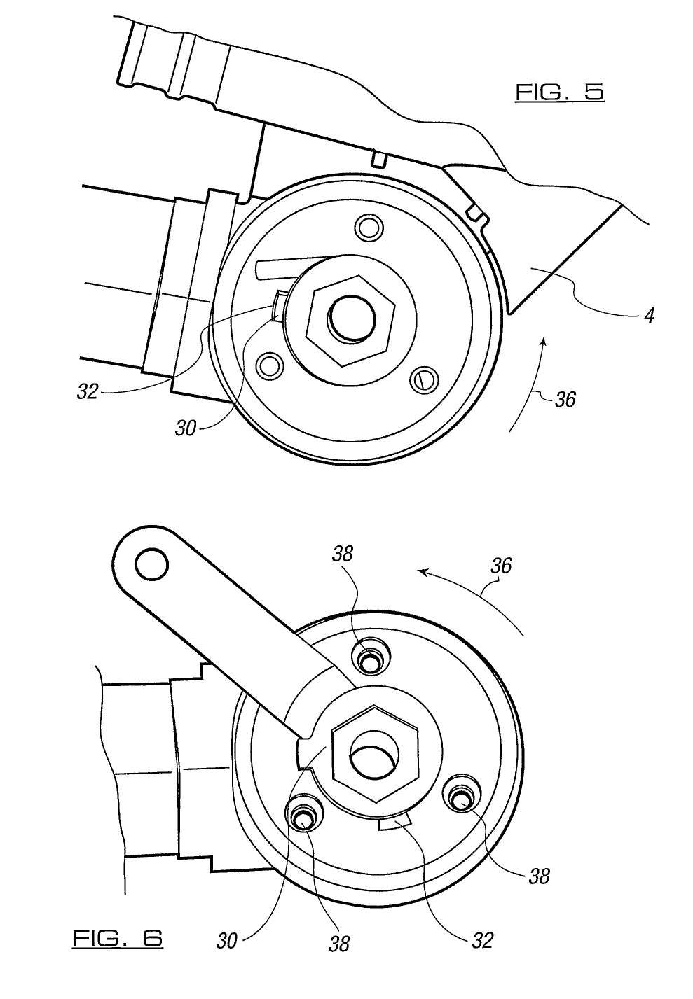

FIG. 4 illustrates one of the components of the apparatus of FIG. 1;

FIG. 5 illustrates a further stage of the method;

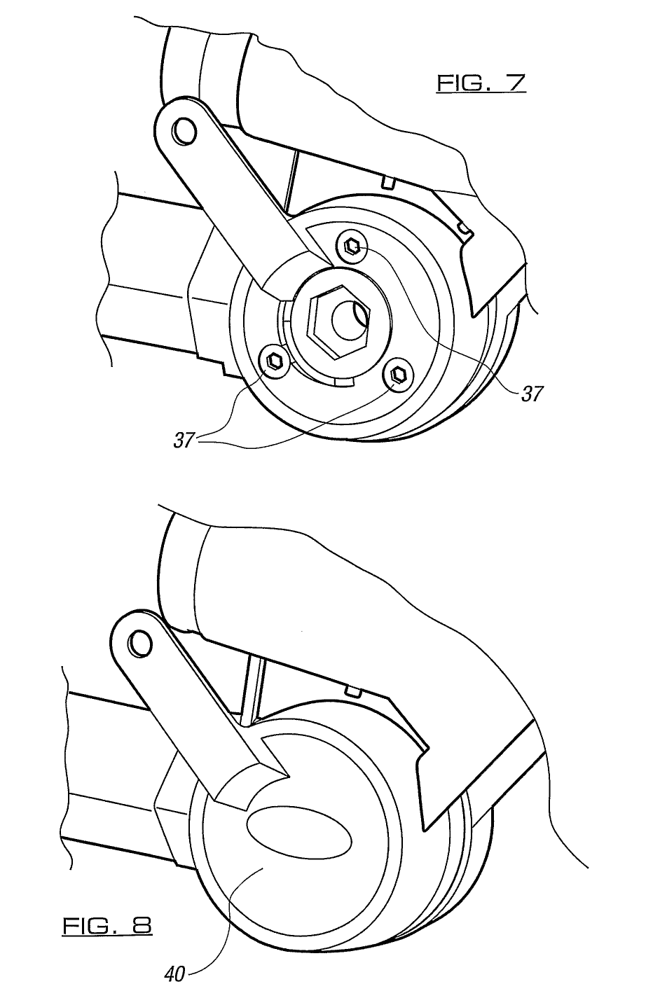

FIGS. 6 to 8 illustrate further stages of the method; and

FIG. 9 illustrates a power tool incorporating the invention in one embodiment.

Referring firstly to FIG. 9 there is shown in schematic fashion a power tool 100 in the form of a mitre saw. The saw includes a base 102 on which a workpiece 104 can be located to be cut. A cutting head 106 is provided to be pivotally moved about pivot axis 12 between a raised position as shown and a lowered cutting position as indicated by arrow 111 in which the rotating blade 108 on the cutting head 106 cuts the workpiece 104. The cutting head and/or apportion thereof such as blade guard mechanism is biased to a default, safety, position by a spring 18 mounted about the axis 12. This means that when the cutting head is to be moved down as indicated by arrow 111 the force of the spring has to be overcome, and when the cutting head is released the same will automatically return to the raised position. The movable guard 112 is provided to enclose the blade 108 when the cutting head is in the raised position and partially expose the blade for cutting when the cutting head is lowered. A guard movement mechanism 114 is provided which locates on an anchor part 4 and which causes the movement of the guard to be actuated upon the pivotal movement of the cutting head. This therefore means that the guard can be moved to the blade exposed position in time for the blade reaching the workpiece but also ensure that the blade is covered as the cutting head moves back to the raised position under the influence of the spring.

At the time of assembly of the power tool there is a need to tension the spring and at the same time assemble the components around the axis 12. This can be difficult to achieve successfully and safely and a means of achieving this is now described in accordance with the invention.

Referring now to FIG. 1, there is illustrated the components of the mitre saw at the pivot axis 12. The components shown are in the form of a radial arm or slide 2 on the base and an anchor piece 4 for location with the guard movement mechanism of the cutting head of a mitre saw. The component 4 is attached to a fixed pivot bracket 8 on the radial arm or slide which is provided with a central spigot 10 mounted around the pivot axis 12. A tapered plug 14 is also shown.

The anchor piece 4 is provided to allow the same to be pivotally movable as indicated by arrow 16 and be returned to a default position under the influence of the spring.

Referring now to FIG. 2, there is illustrated a first stage of the method of forming the apparatus shown in FIG. 1. This stage includes the fitting of a torsion spring 18 around the central spigot. The torsion spring has two arms 20, 22 and one of these arms 20 is moved, as indicated by arrow 24 through a slot 26 in the pivotal bracket. Thus the spring coil 18 is located over the spigot with arm 20 near the slot 26. The spring is then rotated so that arm 20 passes through slot 26.

As shown in FIG. 3, the arm continues to be rotated on the opposing side of the bracket as shown in FIG. 3 which shows the opposing face of the bracket from that shown in FIG. 2. The movement of the arm 20 as indicated, also acts to move the other arm 22 of the spring into an up position so that the same can then be located with the guard anchor component 4 shown in FIG. 4. The component 4 has an abutment 28 which is positioned behind the arm 20 of the torsion spring. A lug 30 on the spigot passes through a slot 32 on the guard component 4. With mutual engagement between the guard anchor component 4 and the spring, the guard anchor component can then be rotated to tension the spring as indicated in FIG. 5 by arrow 36. When the rotation is stopped, lug 30 prevents the guard component 4 from slipping off the arm 22 of the spring and, with the spring now tensioned locating means in the form of screws 37 can then be inserted into apertures 38 to secure the components in this arrangement and thereby arrive at the finished apparatus as shown in FIG. 7 in which the spring is tensioned and retained in that position to allow the spring to bias the movement of the guard and/or cutting head as it is raised.

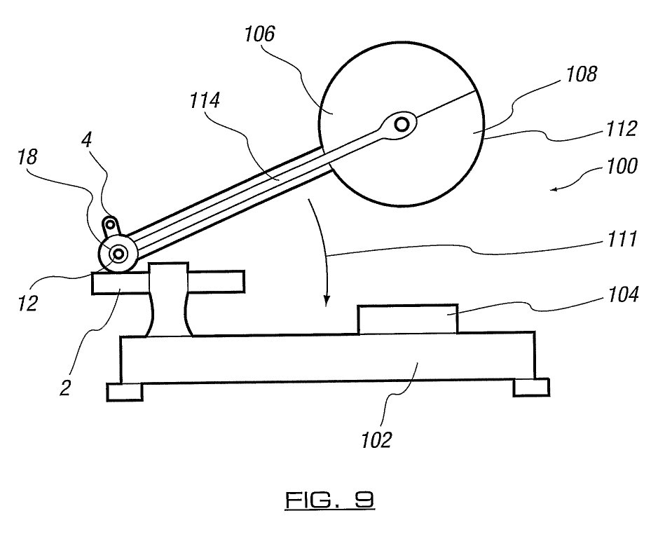

If required, and in order to prevent subsequent operation of this arrangement and hence maintain the torsion spring in tension, a label 40 or other masking means can be attached over the same pivoted bracket 6 as shown in FIG. 8.

1: Apparatus including a torsion spring which acts to provide a biasing force, said apparatus including a pivotal connection between first and second components, provided under the influence of the spring so as to allow at least one of the components to be biased to a position with respect to the other of the components about said pivot axis, said spring including a coil and first and second arms depending from the coil, said apparatus having location means for at least a first arm of the torsion spring, and wherein a portion of the apparatus is rotated about the pivot axis to move one of the arms with respect to the other of the arms to tension the spring at which stage the said arms are retained in position.

2: Apparatus according to claim 1 wherein the location means for the first arm is a slot into which said arm is fitted.

3: Apparatus according to claim 2 wherein said slot is located with regard to the first and second component of the apparatus such that the second arm is then positioned for engagement with the component of the apparatus which is to be pivotally moved.

4: Apparatus according to claim 1 wherein the spring coil is positioned on a spigot.

5: Apparatus according to claim 4 wherein said spigot is coaxial with the pivot axis and said spigot serves to centre the spring.

6: Apparatus according to claim 4 wherein the spigot and location means for the first arm are located on the same component.

7: Apparatus according to claim 6 wherein the location means includes a slot through which the arm passes onto an opposing side of the component from the spigot, and rotation of the spring places both arms in position for subsequent use.

8: Apparatus according to claim 7 wherein once the arms are in the required position, the other of the first and second components is attached for rotation about the pivotal axis, and locating with at least one of the arms such that subsequent rotation of the component causes tensioning of the spring.

9: Apparatus according to claim 1 wherein locking means are provided to retain the spring in a tensioned position and said first and second components can be relatively rotated under the influence of the tension spring.

10: Apparatus according to claim 9 wherein when a movement force is released, the spring acts to return one of the components to a default position with respect to the other component or components.

11: Apparatus according to claim 1, wherein the apparatus is provided as part of a power tool in the form of any of a mitre saw, chop saw or compound saw.

12: Apparatus according to claim 11 wherein the tension spring acts to return the cutting head and/or a portion thereof to a default safety position when the movement force is released from the cutting head.

13: A method for tensioning a torsion spring provided as part of a power tool having a cutting head pivotally movable about a pivot axis between raised and lowered positions with respect to a fixed component on which the cutting head is mounted, said method comprising the steps of providing the torsion spring with first and second arms at opposing ends of the spring coil, placing the spring coil over a spigot mounted at the pivot axis, locating a first arm of the torsion spring with location means on a fixed component, and the second arm with location means on a second component and wherein the second component is rotated about the pivot axis to provide relative movement of the first and second arms and tension the torsion spring and locking means are then fitted to retain the torsion spring in the tensioned position.

14: A method according to claim 13 wherein the fixed component is the base of a mitre or chop saw or a part connected thereto.
